(19) United States
(12) Patent Application Publication
(10) Pub. No.: US 2009/0153016 A1
(43) Pub. Date: Jun. 18, 2009

(54) COLORED FLUORESCENT LAMP

(75) Inventors: Csaba Koronya, Kossuth (HU); Gyorgy Vukics, Urhajos (HU)

Correspondence Address: Fay Sharpe LLP, 1228 Euclid Avenue, 5th Floor, The Halle Building, Cleveland, OH, 44115, US

(73) Assignee: General Electric Company

(21) Appl. No.: 11/958,046

(22) Filed: Dec. 17, 2007

(51) Int. Cl. H01J 1/62

(52) U.S. Cl. 313/485

(57) ABSTRACT

A colored fluorescent lamp is provided. The lamp comprises an envelope having an inner surface, means for providing discharge within the envelope, a discharge gas fill inside the envelope, a phosphor coating adjacent to the inner surface of the envelope, and at least a barrier coating between the inner surface of the envelope and the phosphor coating. The barrier coating comprises a blend of alumina and at least one coloring pigment.

### FIELD OF THE INVENTION

This invention relates to colored fluorescent lamps, and more particularly to colored fluorescent lamps that comprise an envelope and at least a phosphor coating and a barrier coating deposited on an inner surface portion of the envelope.

### BACKGROUND OF THE INVENTION

In certain applications of fluorescent lamps, for example in applications for entertainment purposes, a colored light other than a white one is desired. In case of conventional fluorescent lamps such as for example low-pressure fluorescent lamps, an outer covering layer on the envelope provides a color of the emitted light. A patent abstract published under No. JP 59217939 discloses a double envelope structure, in which the outer envelope is provided with a coloring layer on its inner surface. Though the environmental pollution in case of using such lamps is reduced, the manufacturing costs of an additional outer envelope are too high.

The glass material of the envelope, the tube or the bulb, which is basically transparent, can also be colored. This is too expensive, and only a few colors are accessible since only a few additive agents are capable of mixing with the glass material.

Another way of coloring the output light is to use a color filter or paint layer applied to the outer surface of the envelope. This requires a further step in the manufacturing technology and the resulted lamp is sensitive to mechanical impacts, such as scratches.

A further possible way of coloring fluorescent lamps is doping the phosphor by pigments. A possible solution is known, for example from patent abstract published under No. JP 58004243. A phosphor suspension is colored with an organic dye and the suspension is then applied to the inner wall of a glass tube of the envelope. The tube becomes colored after being dried. This and similar methods have a drawback that the colored phosphor suspension cannot be recycled in any customary manner.

When fluorescent lamps belonging to the state of art are manufactured, a barrier coating is usually applied to an inner glass surface of the envelopes, which is used for different purposes. These purposes are, for example, improving lumen maintenance, reducing mercury consumption, reducing light deterioration at the ends of the envelope, and for providing conductive additional starting aids. The barrier coating forms a barrier between the phosphor coating and the glass envelope. Fluorescent lamp barrier coatings typically comprise alumina or silica particles. These barrier coatings are quite thin, generally less than 1-0.5 micrometer of thickness. The barrier coating is highly transparent to visible light, while an amount of ultraviolet light is beneficially reflected back into the phosphor layer. The most important purpose of the barrier coating is to provide a chemically inert boundary between the phosphor layer and the glass material of the envelope. U.S. Pat. No. 5,602,444 shows an example for a barrier coating, which effectively reflects ultraviolet light back into the phosphor layer. Efficient reflection is highly desirable for improved phosphor utilization, which becomes particularly important when expensive rare earth phosphors are used.

U.S. Pat. No. 5,258,689 discloses a fluorescent lamp having two light-transparent coatings or layers of different refractive index disposed adjacent to each other and on the inner surface of the lamp glass envelope. This double layer barrier coating comprises particles of two different size ranges, which results in a reduced ability of the two layers structure to act as an optical interference filter. These two referred US patents however, do not provide hints for changing the color of the emitted light.

There is a particular need for a colored fluorescent lamp with a barrier coating that can be manufactured easily and cost effectively without any additional step in the usual manufacturing technology.

There is also a need for fluorescent lamps that can be manufactured with different colors of broad variety.

### SUMMARY OF THE INVENTION

In an exemplary embodiment of the invention, a colored fluorescent lamp is provided. This colored fluorescent lamp comprises an envelope having an inner surface, means far providing discharge within the envelope, a discharge gas fill inside the envelope, a phosphor coating adjacent to the inner surface of the envelope, and at least a barrier coating between the inner surface of the envelope and the phosphor coating. The barrier coating comprises a blend of alumina and at least one coloring pigment.

The fluorescent lamps having such barrier coating do not need any new procedural steps in the course of manufacture. The necessary quantity of doping pigments is low, and consequently the manufacturing costs are only slightly higher than those of the conventional fluorescent lamps. At the same time, the available light colors cover a broad range.

### BRIEF DESCRIPTION OF THE DRAWINGS

The invention will now be described with reference to the enclosed drawings, where

FIG. 1 is a perspective view of a partially broken section of a fluorescent lamp, as one embodiment of the invention, which comprises a barrier coating and a phosphor coating,

FIG. 2 illustrates a partial section of an electrodeless compact fluorescent lamp, as another embodiment of the invention, which comprises a barrier coating and a phosphor coating,

FIG. 3 is a chromaticity diagram (CIE) including x, y coordinate pairs of colors.

### DETAILED DESCRIPTION OF THE INVENTION

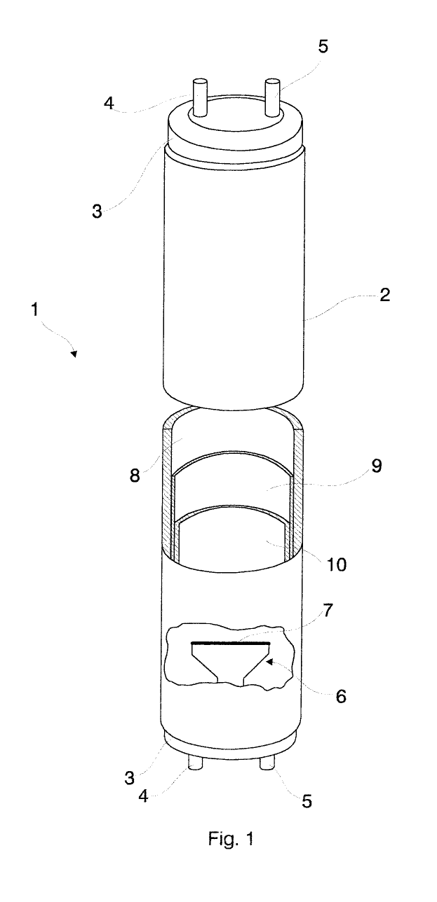

FIG. 1 illustrates a fluorescent lamp 1 of an exemplary embodiment of the invention, in which the lamp 1 comprises an outer envelope 2 with bases 3 at its ends. The envelope 2 is a hermetically sealed glass tube provided with contact pins 4 and 5 at each base 3. The contact pins are to be connected to an associated power supply. The envelope 2 contains a discharge gas fill inside and is sealed in a gas-tight manner. The envelope 2 further comprises means 6 for providing a discharge through the discharge gas fill within the envelope 2. A pair of electrodes 7 and other parts constitutes means 6 for providing discharge. A person skilled in the art knows that the ends of the electrodes 7 are embedded in a glass stem, which is sealed at each end of the envelope 2. The electrodes have a tungsten coil that is coated with an electron emitting material in a manner known in the art. The pins 4, 5 are connected to each of the outer ends of the electrodes 7.

The envelope 2 has an inner surface 8, onto which first a barrier coating 9 and then a commonly used phosphor coating 10 is deposited. It is known for a person skilled in the art that the barrier coating 9 as well as the phosphor coating 10 may be deposited by using a suspension of the material of these coatings. The barrier coating 9 is located between the inner surface 8 of the envelope 2 and the phosphor coating 10. This barrier coating 9 comprises a blend of alumina and at least one coloring pigment. In one embodiment, the coloring pigments are metal oxides. The total amount of the pigment or pigments is less than 5 weight percent with respect to a total weight of a barrier coating suspension in a preferable embodiment. Due to this amount of pigments, the coloring is inexpensive.

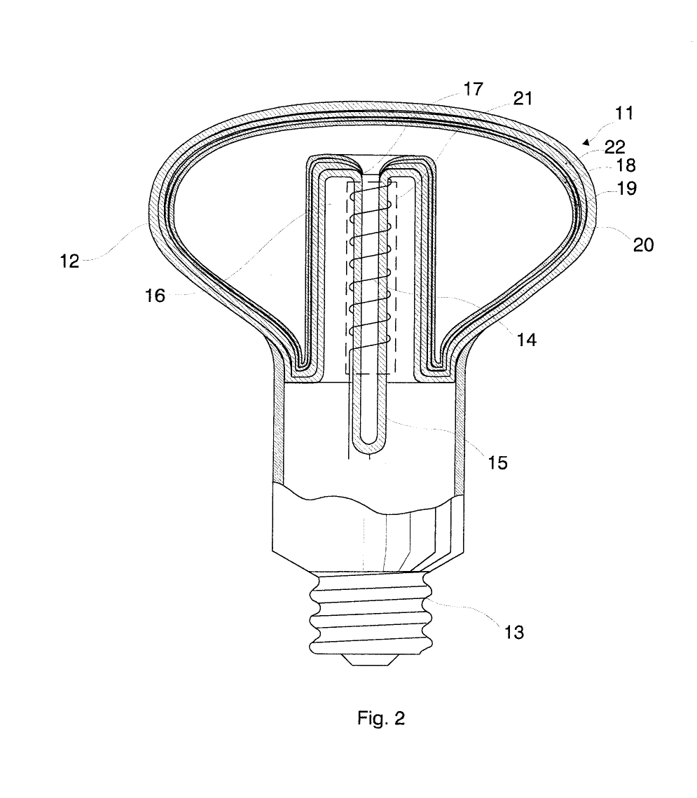

Referring now to FIG. 2, a fluorescent lamp 11 of a further embodiment of the invention can be seen in this figure. The lamp 11 is an electrodeless compact fluorescent lamp that comprises an envelope 12, a lamp base 12, and an exhaust tube 15 within a re-entrant cavity 16 protruding into the inner space of the envelope 12. The exhaust tube 15 has an end portion 17. An excitation coil 14 is disposed on the exhaust tube 15 in order to generate discharge. In this embodiment, the excitation coil forms a means 21 for providing a discharge including a structure, which provides high frequency electromagnetic energy.

The lamp 11 has a layer structure similar to the layer structure of the lamp 1 in FIG. 1. The envelope 12 has an inner surface 20, onto which first a barrier coating 19 and then a commonly used phosphor coating 18 are deposited. The barrier coating 19 in this embodiment is also located between the inner surface 20 of the envelope 12 and the adjacent phosphor coating 18. The barrier coating 19 and the phosphor coating 18 extend to the end portion 17 of the exhaust tube 15. The barrier coating 19 comprises a blend of alumina and at least one coloring pigment. In an embodiment, an additional coating 22 may also be used for reducing the electromagnetic radiation caused by the excitation coil 14 of the electrodeless compact fluorescent lamp 11 out of the envelope 12. This additional coating 22 may be disposed between the barrier coating 19 and the inner surface 20 of the envelope 12 and made of fluorine doped tin oxide. The purpose with this additional coating 22 is to reduce harmful interference with devices working on frequencies close to the frequency of the excitation coil 14 in the vicinity of the electrodeless lamp 11.

In an exemplary embodiment, the at least one pigment in the blend is selected from the group of red, green, blue and yellow pigments. These pigments can for example be the following compounds: iron oxide, chromium-cobalt oxide, sodium-aluminum silicate, and nickel titanate. For stability reasons, the total amount of the pigments is preferably less than 5 weight percent with respect to a total weight of a barrier coating suspension.

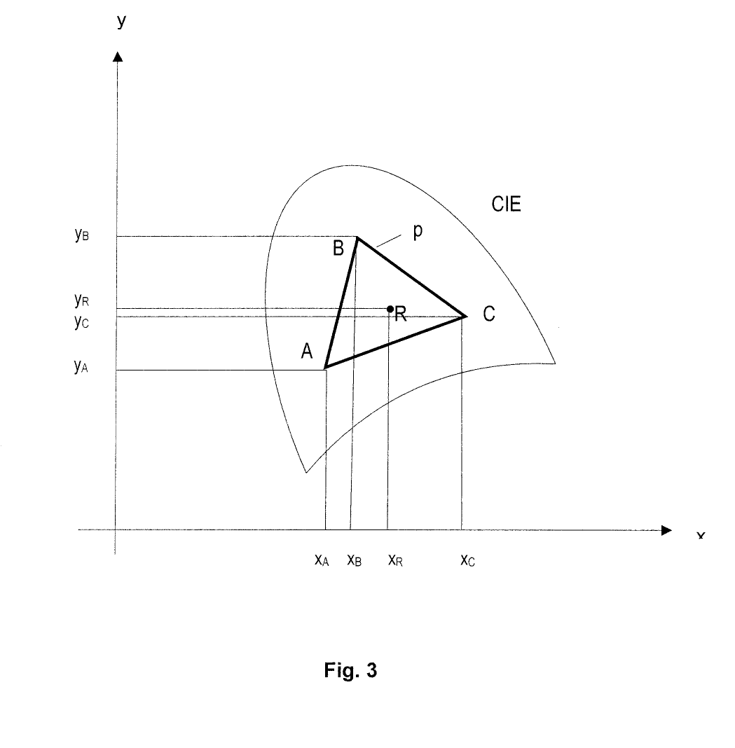

In an embodiment, in which at least three different color pigments are present in the blend, the pigments provides the possibility of mixing color components and thus obtaining a wide variety of complex colors. The commonly used means for handling color components is the CIE chromaticity diagram. Referring now to FIG. 3, there is shown a CIE chromaticity diagram including three different x, y coordinate pairs, which define a polygon. The points A, B, C in the diagram are taken for illustration purposes only, without identifying those as colors of real pigments. The corresponding pairs of xylem coordinates are x_{A}, y_{A}; x_{B}, y_{B}; and x_{C}, y_{C}, respectively. The three points A, B, C together determine a polygon p, in this specific case a triangle within the diagram. If the colors assigned to points A, B and C are mixed, using a given ratio relative to each other, and thus a weighted sum of the coordinates, i.e. x_{A}, x_{B}, x_{C}, and y_{A}, y_{B}, y_{C} determine a resultant color point R of coordinates x_{R}, y_{R} within said polygon p, namely within the triangle. The weighing coefficients in connection with summarizing of coordinate values might be different from the proportional rates of weights of the pigments, depending on their coloring efficiency. In the following, an example of tested pigments is described.

Example 1 relates to an exemplary embodiment of the invention with respect to electrodeless lamps.

### Example 1

The following four pigments were used in different electrodeless lamps:
BAYFERROX 110M from BAYER AG, Germany, as iron oxide red;
Cobalt Green 6001 from CERDEC AG, Germany, as cobalt green;
Ultramarine Blue 14304 from Chemische Farbenfabrik HABICH AG, Austria, as ultramarine blue;
Nickel Titania Yellow 4566 from Chemische Farbenfabrik HABICH AG, Austria, as nickel titania yellow.

These are pigments usually used for colored incandescent lamps. It is to be noted that several other pigment types can be used in order to create other colors.

The pigments were put into usual barrier coating suspension of Degussa Aeroxide C, and the suspension was applied to electrodeless lamps. Each pigment was used in an amount of 1 weight % with respect to the total weight of suspension. First the suspension was homogenized in ultrasonic bath, and then poured into the electrodeless bulbs with and without fluorine doped tin-oxide coating. A few seconds after pouring the suspension into the bulbs, they were put in drying position of a barrier coater apparatus. Subsequently, the bulb envelopes were processed as usual coated bulbs of electrodeless lamps.

Table 1 shows several colors created by a barrier coating and identified by their x, y color coordinates in a chromaticity diagram (CIE). The color measurement of the barrier coating was carried out after 4 hour burning.

TABLE 1

| | x | y |
|---|---|---|
| 2700K/White | 0.313 | 0.321 |
| 2700K/Red | 0.318 | 0.330 |
| 2700K/Green | 0.363 | 0.337 |
| 2700K/Blue | 0.311 | 0.334 |
| 2700K/Yellow | 0.281 | 0.286 |

Table 2 shows the same values after 500 hour burning.

TABLE 2

| | x (CIE) | y (CIE) |
|---|---|---|
| 2700K/White | 0.314 | 0.322 |
| 2700K/Red | 0.318 | 0.329 |
| 2700K/Green | 0.359 | 0.331 |
| 2700K/Blue | 0.310 | 0.329 |
| 2700K/Yellow | 0.294 | 0.303 |

Table 3 shows the photometry results of colored electrodeless lamps after different burning hours. Values in the columns refer to the colors of the pigments used, the obtained luminous output in lumens (Lm), the maintenance of this lumen value, the corrected color temperature (CCT) in K, the CIE x, y coordinates and the resulted wattage for the differently colored lamps, after different burning times.

TABLE 3

| Burning | Color of | Light | Lumen | | | | Wattage |
|---|---|---|---|---|---|---|---|
| hours (h) | pigment | (Lm) | maintenance (%) | CCT (K) | x (CIE) | y (CIE) | (W) |
| 100 | Blue | 790 | 100.0% | 2923 | 0.438 | 0.397 | 22.18 |
| 500 | Blue | 764 | 96.8% | 2955 | 0.438 | 0.399 | 22.19 |
| 1000 | Blue | 785 | 99.4% | 2889 | 0.442 | 0.401 | 22.34 |
| 2500 | Blue | 770 | 97.5% | 2870 | 0.443 | 0.403 | 22.08 |
| 5000 | Blue | 759 | 96.1% | 2797 | 0.450 | 0.404 | 22.34 |
| 100 | Green | 939 | 100.0% | 2938 | 0.444 | 0.412 | 22.26 |
| 500 | Green | 890 | 94.7% | 2961 | 0.442 | 0.411 | 22.23 |
| 1000 | Green | 879 | 93.6% | 2950 | 0.443 | 0.411 | 22.29 |
| 2500 | Green | 858 | 91.3% | 2928 | 0.444 | 0.411 | 22.28 |
| 5000 | Green | 833 | 88.6% | 2878 | 0.448 | 0.411 | 22.40 |
| 100 | Red | 708 | 100.0% | 2320 | 0.481 | 0.396 | 22.23 |
| 500 | Red | 672 | 95.0% | 2328 | 0.480 | 0.396 | 22.35 |
| 1000 | Red | 670 | 94.7% | 2321 | 0.481 | 0.396 | 22.43 |
| 2500 | Red | 646 | 91.3% | 2317 | 0.480 | 0.396 | 22.55 |
| 5000 | Red | 616 | 87.0% | 2353 | 0.483 | 0.395 | 22.39 |
| 100 | Yellow | 1033 | 100.0% | 2771 | 0.455 | 0.412 | 22.63 |
| 500 | Yellow | 949 | 91.8% | 2820 | 0.451 | 0.409 | 22.30 |
| 1000 | Yellow | 921 | 89.1% | 2845 | 0.448 | 0.407 | 21.93 |
| 2500 | Yellow | 897 | 86.8% | 2836 | 0.449 | 0.408 | 21.93 |
| 5000 | Yellow | 870 | 84.2% | 2780 | 0.453 | 0.408 | 22.11 |
| 100 | White ref | 1039 | 100.0% | 2700 | 0.451 | 0.405 | 22.30 |
| 500 | White ref | 1000 | 96.2% | 2700 | 0.452 | 0.404 | 22.10 |

The last two rows indicate relevant values of a white reference light source.

This invention may be used in any fluorescent lamps, such as for example linear fluorescent lamps, compact fluorescent lamps electrodeless compact fluorescent lamps that contain barrier coating.

This invention has been described with reference to the preferred embodiments. Obviously, modifications and alterations will occur to one skilled in the art upon reading and understanding the preceding detailed description. It is intended that the invention be construed as including all such modifications and alterations.

1. A colored fluorescent lamp comprising an envelope having an inner surface, means for providing discharge within the envelope, a discharge gas fill inside the envelope, a phosphor coating adjacent to the inner surface of the envelope, and at least a barrier coating between the inner surface of the envelope and the phosphor coating, the barrier coating comprising a blend of alumina and at least one coloring pigment.

2. The lamp of claim 1, in which the means for providing discharge comprises electrodes.

3. The lamp of claim 1, in which the means for providing discharge comprises a structure providing high frequency electromagnetic energy.

4. The lamp of claim 3, in which an additional coating is disposed between the barrier coating and the inner surface of the envelope for reducing electromagnetic radiation out of the envelope.

5. The lamp of claim 4, in which the additional coating comprises fluorine doped tin oxide.

6. The lamp of claim 1, in which the at least one coloring pigment is a metal oxide.

7. The lamp of claim 1, in which total amount of the at least one coloring pigment is less than 5 weight percent with respect to total weight of a barrier coating suspension.

8. The lamp of claim 1, in which the at least one coloring pigment is selected from the group of red, green, blue and yellow pigments.

9. The lamp of claim 8, in which the red pigment is iron oxide red.

10. The lamp of claim 8, in which the green pigment is cobalt green.

11. The lamp of claim 8, in which the blue pigment is ultramarine blue.

12. The lamp of claim 8, in which the yellow pigment is nickel titania yellow.
